(19) United States
(12) Patent Application Publication
(10) Pub. No.: US 2025/0163275 A1
(43) Pub. Date: May 22, 2025

(54) FLAME-RESISTANT THREE-DIMENSIONAL PRINTED ARTICLES

(71) Applicant: Hewlett-Packard Development Company, L.P., Spring, TX (US)

(72) Inventors: Shannon Reuben Woodruff, San Diego, CA (US); Jayprakash C. Bhatt, Corvallis, OR (US)

(21) Appl. No.: 18/839,693

(22) PCT Filed: Feb. 25, 2022
(86) PCT No.: PCT/US2022/017835

§ 371 Date: Aug. 19, 2024

(51) Int. Cl. C09D 4/06; B29C 64/165; B29C 64/30; B29K 77/00; B33Y 10/00; B33Y 40/20; B33Y 80/00; C09D 7/45; C09D 7/63; C09D 133/04; C09D 177/02

(52) U.S. Cl. CPC C09D 4/06; B29C 64/30; B33Y 40/20; B33Y 80/00; C09D 7/45; C09D 7/63; C09D 133/04; C09D 177/02; B29C 64/165; B29K 2077/00; B33Y 10/00

(57) ABSTRACT

A composition for coating a three-dimensional printed article includes at least one non-polymeric, polyhalogenated organic compound, at least one surfactant, and at least one solvent, and optionally includes at least one film forming polymer at a concentration of up to about 10 wt. % of the composition. A method of making a flame-resistant coated article includes coating the article with the liquid flame retardant composition.

### BACKGROUND

Three-dimensional (3D) digital printing is a type of additive manufacturing that has been and continues to be developed and refined for specific purposes over the years. In general, three-dimensional printing technology allows for rapid creation of both prototype models for reviewing and testing and also consumer products. However, three-dimensional printing has been somewhat limited with respect to commercial production capabilities because the range of materials used in three-dimensional printing is likewise limited. One such limitation is low availability of workable flame-resistant materials in three-dimensional printing, and in turn, limited ability to thereby manufacture flame-resistant components. That stated, a wider variety of materials for use and new and/or modified three-dimensional printing applications has provided increased interest in this area in recent years.

### BRIEF DESCRIPTION OF THE DRAWINGS

FIG. 1 is a schematic view of an example multi-fluid kit for three-dimensional printing in accordance with examples of the present disclosure.

FIGS. 2A-2C show a schematic view of an example three-dimensional printing process using an example three-dimensional printing kit in accordance with examples of the present disclosure.

### DETAILED DESCRIPTION

The present disclosure describes a method for making a flame-resistant three-dimensional printed article, and materials used for coating three-dimensional printed articles with at least one material in order to impart flame-resistance to the articles. The present disclosure overcomes obstacles conventionally problematic to finding suitable coating materials such as increasing the article thickness, poor aesthetics, and incompatibility of a coating agent with the article's base material.

The present description more particularly discloses that fire resistance is obtained by using a composition for coating a three-dimensional printed article, the composition including a non-polymeric, polyhalogenated organic compound, a surfactant, and a solvent. The coating composition optionally further includes a film forming polymer at a concentration of up to 10 wt. % of the coating composition.

The composition has a surfactant concentration suited for thoroughly combining the non-polymeric, polyhalogenated organic compound, and the film forming polymer when present, in the solvent. The surfactant may be anionic, cationic, amphoteric, or nonionic or a combination of such depending on the composition components and their characteristics. Some example surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 or TEGO® Twin 4000 (both organic surfactants) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

According to one example the surfactant may be included at a concentration ranging between about 0.1 and about 4 wt. % based on the total weight of the coating composition. In an example the total amount of surfactant may be less than 2% based on the total weight of the coating composition.

According to one example the non-polymeric polyhalogenated organic compound has an unusually high heteroatom (non-carbon) content, which is defined as a ratio of the total non carbon or hydrogen atoms in the molecule to the total carbon atoms in the molecule. The high heteroatom content alludes to potential for both high intumescence and effective radical combustion reaction interference in the gas phase, thus leading to projected exceptional flame retardance even at low concentrations. The non-polymeric polyhalogenated organic compound may have a heteroatom content as a ratio of at least 7/10 or 0.7.

Example non-polymeric, polyhalogenated organic compounds that have a high heteroatom concentration include one or more of the following:

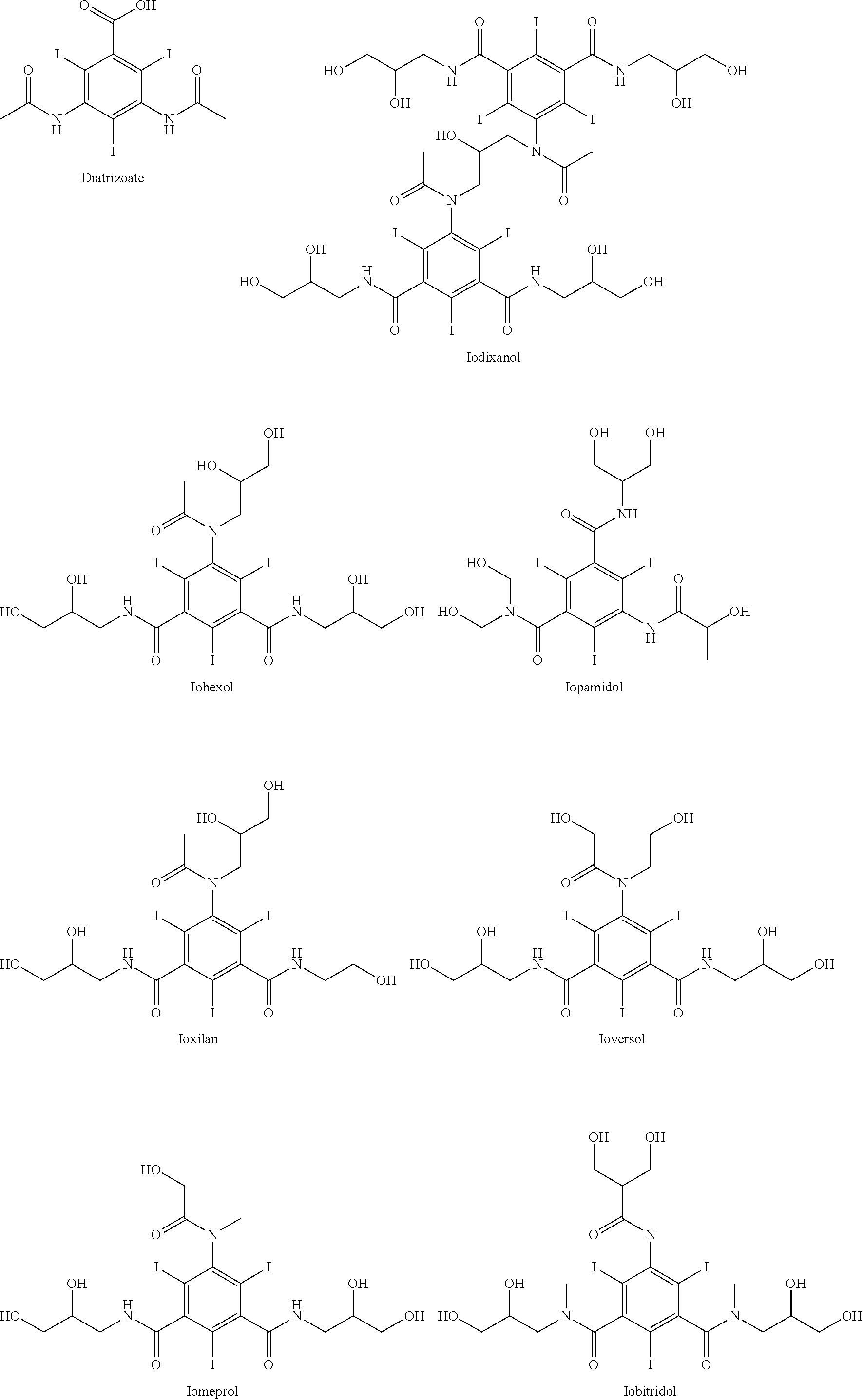

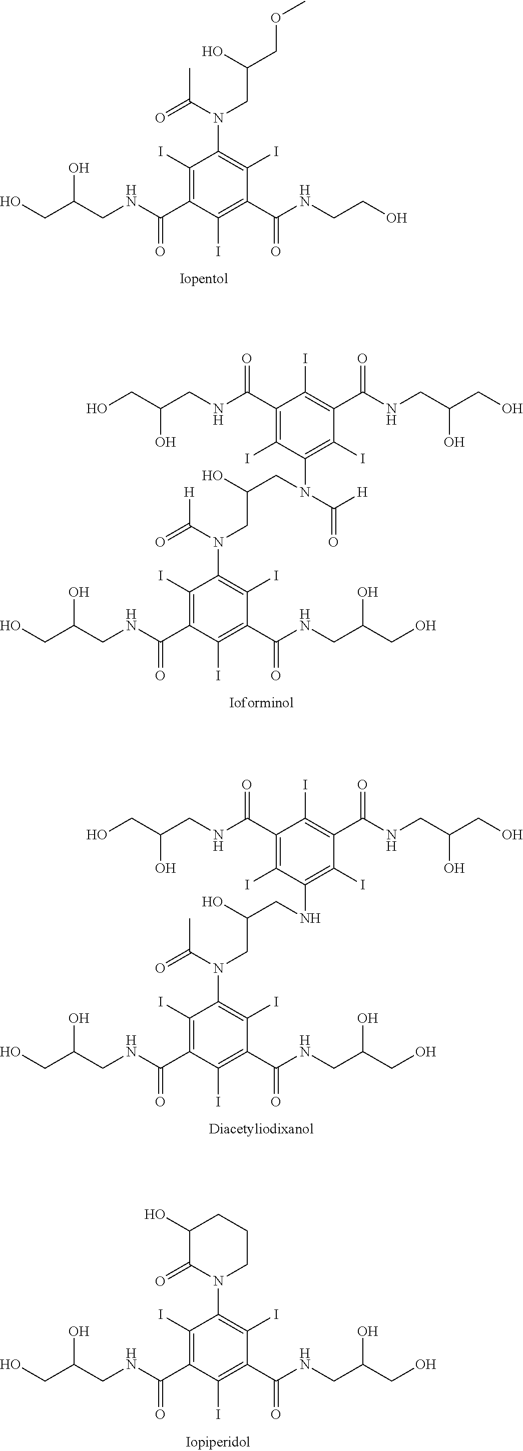 [SMILES: COCC(O)CN(C(C)=O)c1c(I)c(C(=O)NCCO)c(I)c(C(=O)NCC(O)CO)c1I ; O=CN(CC(O)CN(C=O)c1c(I)c(C(=O)NCC(O)CO)c(I)c(C(=O)NCC(O)CO)c1I)c1c(I)c(C(=O)NCC(O)CO)c(I)c(C(=O)NCC(O)CO)c1I ; CC(=O)N(CC(O)CNc1c(I)c(C(=O)NCC(O)CO)c(I)c(C(=O)NCC(O)CO)c1I)c1c(I)c(C(=O)NCC(O)CO)c(I)c(C(=O)NCC(O)CO)c1I ; O=C(NCC(O)CO)c1c(I)c(C(=O)NCC(O)CO)c(I)c(N2CCCC(O)C2=O)c1I]

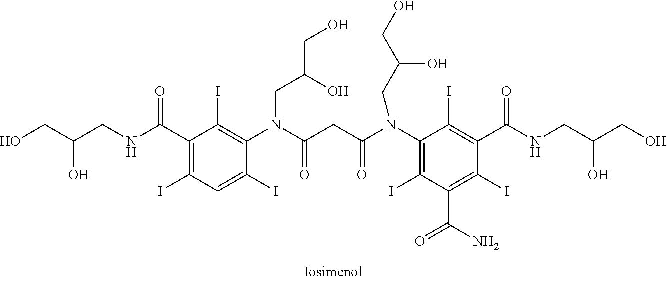 [SMILES: NC(=O)c1c(I)c(C(=O)NCC(O)CO)c(I)c(N(CC(O)CO)C(=O)CC(=O)N(CC(O)CO)c2c(I)cc(I)c(C(=O)NCC(O)CO)c2I)c1I]

The advantages imparted by use of the non-polymeric, polyhalogenated organic compound may include nontoxic and metabolically inert compositions and coatings that do not negatively change the appearance of parts unlike current coatings. The coating compositions have high solubility in aqueous media, leading to potential for environmentally responsible formulations.

The coating composition may include a film forming polymer as well. The film forming polymer is included at a concentration of up to about 10 wt. % of the composition based on the total weight of the coating composition. In one example the film forming polymer is included at a concentration of less than about 8% or even 5% based on the total weight of the coating composition. The film forming polymer may be included in order to impart adhesion of the coating composition to the coated article in a uniform thin film. Examples of suitable film forming polymers and polymer compositions may include nonionic polymers. Examples of nonionic polymers may include acrylic polymers, acrylamide polymers, vinyl polymers, and copolymers thereof. Some examples may include film forming polymers having a molecular weight ranging between about 1,800 and 18,000. Exemplary nonionic polymers with such molecular weights include Joncryl® acrylic polymer emulsions marketed by BASF. In one example the coating composition includes the acrylic resin Joncryl® 683, which has a molecular weight of about 8,000. In an example the coating composition does not include any additional polymer other than the film forming polymer.

Three-dimensional printing in a general sense involves use of at least two components, namely, a powder bed material comprising polymer particles, and a fusing agent to selectively apply to the powder bed material. A method for manufacturing a three-dimensional printed article may include iteratively applying individual layers of the powder material to a powder bed, and based on a three-dimensional object model, selectively applying the fusing agent onto the individual layers of powder bed material. In many examples the fusing agent includes water and a radiation absorber to absorb radiation energy and convert the radiation energy to heat to fuse the polymer particles.

In further detail, the method can include, based on the three-dimensional object model, selectively and iteratively applying fusing agent to iterative layers of powder bed material, and exposing the powder bed to radiation energy to selectively fuse the polymer particles in contact with the radiation absorber at individual layers and thereby forming the three-dimensional printed article. In another example, applying the fusing agent includes ejecting the fusing agent from a fluidjet printhead. The three-dimensional (3D) printed articles are thereafter coated with a flame-resistant coating composition that includes a polyhalogenated organic compound. The step of coating the articles may be performed by any suitable coating method including dipping the articles into the coating composition, or by spraying, or brushing the coating composition onto the articles.

### Materials for Three-Dimensional Printing

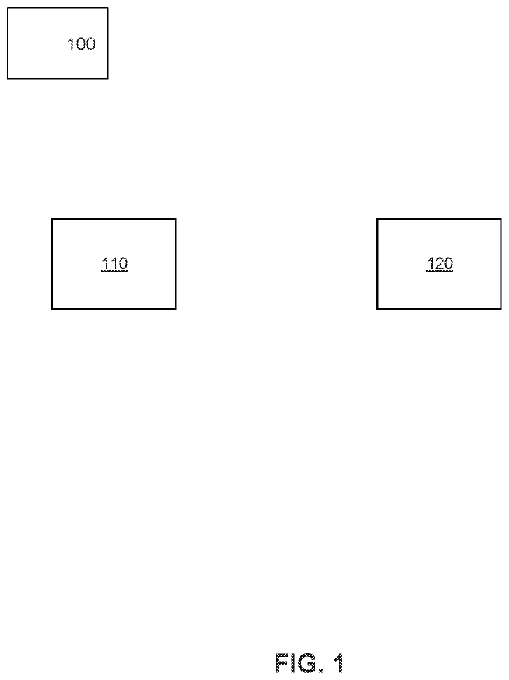

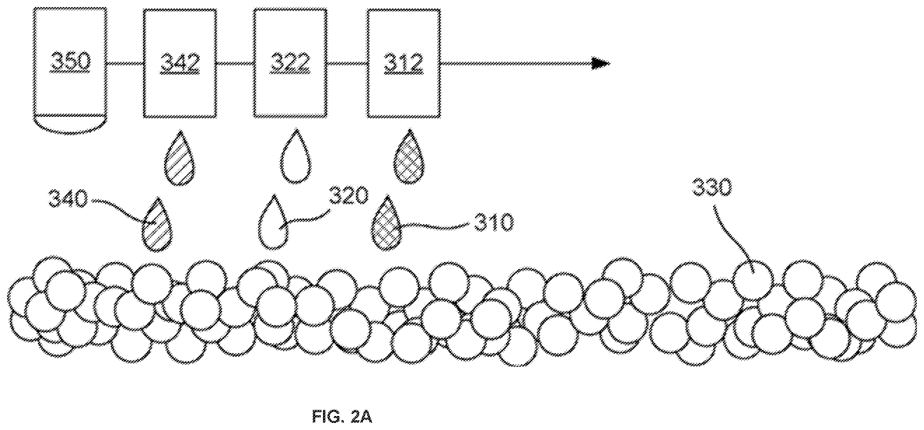

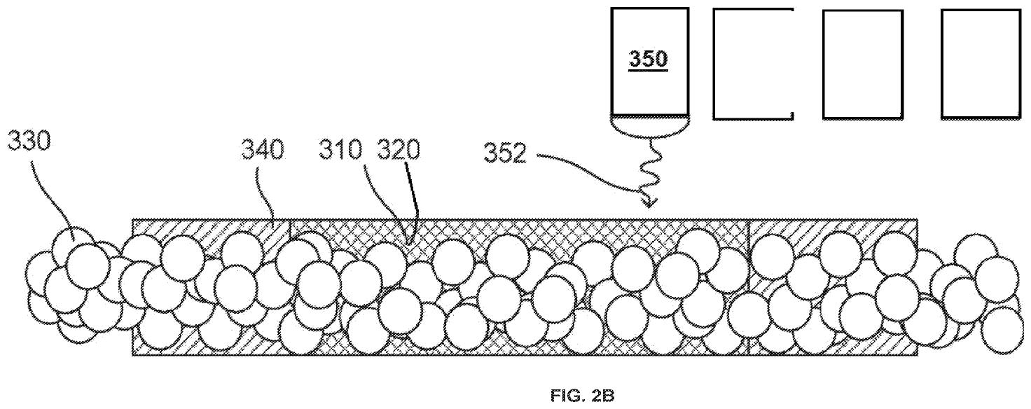

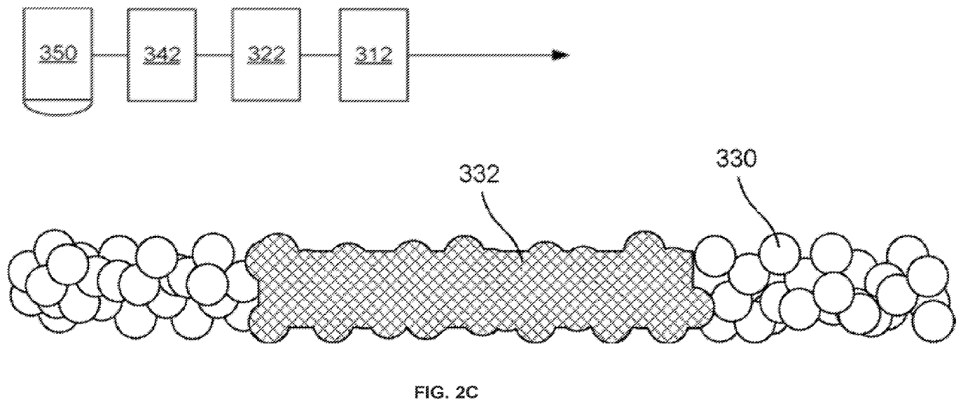

With this description in mind, FIG. 1 shows a schematic illustration of example materials 100 for multi jet fusion (MJF) three-dimensional printing. The materials 100 include a fusing agent 110. The fusing agent can include water and a radiation absorber. The radiation absorber can absorb radiation energy and convert the radiation energy to heat.

The materials 100 also include a powder bed material 120 that includes a polymer powder. In some examples, the polymer powder has a melting point temperature from about 70° C. to about 350° C.

In other examples, the materials 100 also include other fluids, such as detailing agents, coloring agents, or the like. For example, the detailing agent can include a detailing compound, which is a compound that can reduce the temperature of powder bed material onto which the detailing agent is applied. In some examples, the detailing agent can be applied around edges of the area where the fusing agent is applied. This can prevent powder bed material around the edges from caking due to heat from the area where the fusing agent was applied. The detailing agent can also be applied in the same area where fusing was applied in order to control the temperature and prevent excessively high temperatures when the powder bed material is fused.

The present disclosure also sets forth three-dimensional printing kits. In some examples, the three-dimensional printing kits include the materials 100 that can be used in the three-dimensional printing processes described herein. The kit includes the powder bed material 120 including polymer particles, and the fusing agent 110 to iteratively and selectively apply to individual layers of the powder bed material.

The three-dimensional printing kits can likewise include multiple fluid agents, such as any combination of a fusing agent, a detailing agent, a coloring agent, a scent agent, and a powder bed material.

To illustrate the use of the three-dimensional printing kits and materials described herein, FIGS. 3A-3C illustrate one example of using a three-dimensional printing kit to form a three-dimensional printed article. In FIG. 3A, a fusing agent 310 and a second agent 320 are jetted onto a layer of powder bed material 330. As also shown in FIGS. 3A-3C, a detailing agent can also be jetted in some more specific examples. The fusing agent is jetted from a fusing agent ejector 312, the second agent, which may for example be a coloring agent is jetted from a second agent ejector 322, and the detailing agent is jetted from a detailing agent ejector 342. Regardless of the specific configuration and/or combinations of fluids (or with a single fluid in some instances) fluid ejectors can move across the layer of powder bed material to selectively jet fusing agent on areas that are to be fused, while the detailing agent can be jetted onto areas that are to be cooled. The second agent can be jetted in areas where the particular second agent is desired. A radiation source 350 can also move across the layer of powder bed material.

FIG. 3B shows the layer of powder bed material 330 after the fusing agent 310 and the scent agent 320 have been jetted onto an area of the layer that is to be fused. Additionally, the detailing agent 340 has been jetted onto areas adjacent to the edges of the area to be fused. In this figure, the radiation source 350 is shown emitting radiation 352 toward the layer of polymer particles. The fusing agent can include a radiation absorber that can absorb this radiation and convert the radiation energy to heat.

FIG. 3C shows the layer of powder bed material 330 with a fused portion 332 where the fusing agent was jetted. This portion has reached a sufficient temperature to fuse the polymer particles together to form a solid polymer matrix. This portion can also include the second agent if it was also jetted in the same area as the fusing agent. The area where the detailing agent was jetted remains as loose polymer particles.

### Powder Bed Material

In certain examples, the powder bed material includes polymer particles having a variety of shapes, such as substantially spherical particles or irregularly shaped particles. In some examples, the polymer powder can be capable of being formed into three-dimensional printed objects with a resolution of about 20 μm to about 100 μm, about 30 μm to about 90 μm, or about 40 μm to about 80 μm. As used herein, “resolution” refers to the size of the smallest feature that can be formed on a three-dimensional printed object. The polymer powder can form layers from about 20 μm to about 100 μm thick, allowing the fused layers of the printed part to have roughly the same thickness. This can provide a resolution in the z-axis (i.e., depth) direction of about 20 μm to about 100 μm. The polymer powder can also have a sufficiently small particle size and sufficiently regular particle shape to provide about 20 μm to about 100 μm resolution along the x-axis and y-axis (i.e., the axes parallel to the top surface of the powder bed) For example, the polymer powder can have an average particle size from about 20 μm to about 100 μm. In other examples, the average particle size can be from about 20 μm to about 50 μm. Other resolutions along these axes can be from about 30 μm to about 90 μm or from 40 μm to about 80 μm.

The polymer powder can have a melting or softening point from about 70° C. to about 350° C. A variety of thermoplastic polymers with melting points or softening points in these ranges can be used. For example, the polymer powder can be polyamide 6 powder, polyamide 9 powder, polyamide 11 powder, polyamide 12 powder, polyamide 6/6 powder, polyamide 6/12 powder, thermoplastic polyamide powder, polyamide copolymer powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, silicone rubber, polypropylene powder, polyester powder, polycarbonate powder, copolymers of polycarbonate with acrylonitrile butadiene styrene, copolymers of polycarbonate with polyethylene terephthalate, polyether ketone powder, polyacrylate powder, polystyrene powder, polyvinylidene fluoride powder, polyvinylidene fluoride copolymer powder, poly(vinylidene fluoride-trifluoroethylene) powder, poly(vinylidene fluoride-trifluoroethylene-chlorotrifluoroethylene) powder, or mixtures thereof.

A specific class of powder bed material is a polyamide material composition, which includes polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

In some examples, the polyamide particles may be in the form of a powder or a powder-like material. The powder-like material includes, for example, short fibers having a length that is greater than its width. In some examples, the powder or powder-like material may be formed from, or may include, short fibers that may, for example, have been cut into short lengths from long strands or threads of material.

The polyamide particles may be made up of similarly sized particles and/or differently sized particles. In an example, the average particle size (e.g., volume-weighted mean diameter of a particle distribution) of the polyamide particles ranges from about 2 μm to about 225 μm. In another example, the average particle size of the polyamide particles ranges from about 10 μm to about 130 μm.

When the polyamide build material composition 22 includes crystalline or semi-crystalline polyamide particles, the polyamide build material composition 22 may have a wide processing window of greater than 5° C., which can be defined by the temperature range between the melting point and the re-crystallization temperature. In an example, the polyamide build material composition 22 may have a melting point ranging from about 50° C. to about 300° C. As other examples, the polyamide build material composition 22 may have a melting point ranging from about 155° C. to about 225° C., from about 155° C. to about 215° C., about 160° C. to about 200° C., from about 170° C. to about 190° C., or from about 182° C. to about 189° C. As still another example, the polyamide build material composition 22 may have a melting point of about 180° C.

When the polyamide build material composition 22 includes thermoplastic polyamide particles, the polyamide build material composition 22 may have a melting range within the range of from about 130° C. to about 250° C. In a specific example, the polymer powder is polyamide 12, which can have a melting point from about 175° C. to about 200° C.

The thermoplastic polymer particles can also in some cases be blended with a filler. The filler can include inorganic particles such as alumina, silica, fibers, carbon nanotubes, cellulose, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, a weight ratio of thermoplastic polymer particles to filler particles can be from about 100:1 to about 1:2 or from about 5:1 to about 1:1

### Fusing Agents

The multi-fluid kits and three-dimensional printing kits described herein can include a fusing agent to be applied to the polymer build material. The fusing agent can include a radiation absorber that can absorb radiant energy and convert the energy to heat. In certain examples, the fusing agent can be used with a powder bed material in a particular three-dimensional printing process. A thin layer of powder bed material can be formed, and then the fusing agent can be selectively applied to areas of the powder bed material that are desired to be consolidated to become part of the solid three-dimensional printed object. The fusing agent can be applied, for example, by printing such as with a fluid ejector or fluid jet printhead. Fluid jet printheads can jet the fusing agent in a similar way to an inkjet printhead jetting ink. Accordingly, the fusing agent can be applied with great precision to certain areas of the powder bed material that are desired to form a layer of the final three-dimensional printed object. After applying the fusing agent, the powder bed material can be irradiated with radiant energy. The radiation absorber from the fusing agent can absorb this energy and convert it to heat, thereby heating any polymer particles in contact with the radiation absorber. An appropriate amount of radiant energy can be applied so that the area of the powder bed material that was printed with the fusing agent heats up enough to melt the polymer particles to consolidate the particles into a solid layer, while the powder bed material that was not printed with the fusing agent remains as a loose powder with separate particles.

In some examples, the amount of radiant energy applied, the amount of fusing agent applied to the powder bed, the concentration of radiation absorber in the fusing agent, and the preheating temperature of the powder bed (i.e., the temperature of the powder bed material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. Generally, the print mode can include any variables or parameters that can be controlled during three-dimensional printing to affect the outcome of the three-dimensional printing process.

Generally, the process of forming a single layer by applying fusing agent and irradiating the powder bed can be repeated with additional layers of fresh powder bed material to form additional layers of the three-dimensional printed article, thereby building up the final object one layer at a time. In this process, the powder bed material surrounding the three-dimensional printed article can act as a support material for the object. When the three-dimensional printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, the radiation absorber can be a near-infrared absorbing conjugated polymer such as poly (3,4-ethylenedioxythiophene)-poly (styrenesulfonate) (PEDOT:PSS), a polythiophene, poly (p-phenylene sulfide), a polyaniline, a poly (pyrrole), a poly(acetylene), poly (p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O, M₄P₂O₉, M₅P₂O, M₃(PO₄)₂, M(PO₃}₂; M₂P₄O₁₂, and combinations thereof, where M represents a counterion having an oxidation state of +2, such as those listed above or a combination thereof. For example, M₂P₂O can include compounds such as Cu₂P₂O, Cu/MgP₂O, Cu/Zn P₂O, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2 For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes Non-limiting specific examples include complexes based on nickel, palladium, and platinum.

In further examples, the radiation absorber can include a tungsten bronze or a molybdenum bronze. In certain examples, tungsten bronzes can include compounds having the formula MxWO₃, where M is a metal other than tungsten and x is equal to or less than 1. Similarly, in some examples, molybdenum bronzes can include compounds having the formula MxMoQ₃, where M is a metal other than molybdenum and x is equal to or less than 1.

In alternative examples, the radiation absorber can preferentially absorb ultraviolet radiation. In some examples, the radiation absorber can absorb radiation in wavelength range from about 300 nm to about 400 nm. In certain examples, the amount of electromagnetic energy absorbed by the fusing agent can be quantified as follows: a layer of the fusing agent having a thickness of 0.5 μm after liquid components have been removed can absorb from 90% to 100% of radiant electromagnetic energy having a wavelength within a wavelength range from about 300 nm to about 400 nm. The radiation absorber may also absorb little or no visible light, thus making the radiation absorber transparent to visible light. In certain examples, the 0.5 μm layer of the fusing agent can absorb from 0% to 20% of radiant electromagnetic energy in a wavelength range from above about 400 nm to about 700 nm. Non-limiting examples of ultraviolet absorbing radiation absorbers can include nanoparticles of titanium dioxide, zinc oxide, cerium oxide, indium tin oxide, or a combination thereof. In some examples, the nanoparticles can have an average particle size from about 2 nm to about 300 nm, from about 10 nm to about 100 nm, or from about 10 nm to about 60 nm.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt % In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

In some examples, the fusing agent can be jetted onto the polymer powder build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the aqueous liquid vehicle formulation can include organic co-solvent(s) present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt % The balance of the formulation can be purified water, and/or other vehicle components such as biocides, viscosity modifiers, materials for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C5-C12) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.

### Detailing Agents

In further examples, three-dimensional printing kits can include a detailing agent. The detailing agent can include a detailing compound. The detailing compound can be capable of reducing the temperature of the powder bed material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polymer powder. Depending on the type of polymer powder used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N, N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not cause the powder printed with the detailing agent to fuse when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

In certain examples, the detailing agent can include from about 1 wt % to about 10 wt % organic co-solvent, from about 1 wt % to about 20 wt % high boiling point solvent, from about 0.1 wt % to about 2 wt % surfactant, from about 0.1 wt % to about 5 wt % anti-kogation agent, from about 0.01 wt % to about 5 wt % chelating agent, from about 0.01 wt % to about 4 wt % biocide, and the balance can be deionized water

### Methods of Making Three-Dimensional Printed Articles

The present disclosure also describes methods of making three-dimensional printed articles. The method can include iteratively applying individual layers of a powder bed material to a powder bed, and based on a three-dimensional object model, selectively applying a fusing agent onto the individual layers of powder bed material. The fusing agent can include water and a radiation absorber to absorb radiation energy and convert the radiation energy to heat, and the powder bed material can include polymer particles. In further detail, the method can further include, based on the three-dimensional object model, optionally selectively applying a second agent as defined herein to the powder bed material, and exposing the powder bed to radiation energy to selectively fuse the polymer particles in contact with the radiation absorber at individual layers and thereby forming the three-dimensional printed article.

The fusing agent, second agent, and/or detailing agent as may be applicable for a given application can be ejected or digitally jetted onto the powder bed using fluidjet printheads. The amount of the fusing agent used can be calibrated based on the concentration of radiation absorber in the fusing agent, the level of fusing desired for the polymer particles, and other factors. In some examples, the amount of fusing agent printed can be sufficient to contact the radiation absorber with the full layer of polymer powder. For example, if individual layers of polymer powder is 100 microns thick, then the fusing agent can penetrate 100 microns into the polymer powder Thus, the fusing agent can heat the polymer powder throughout the entire layer so that the layer can coalesce and bond to the layer below. After forming a solid layer, a new layer of loose powder can be formed, either by lowering the powder bed or by raising the height of a powder roller and rolling a new layer of powder.

In some examples, the entire powder bed can be preheated to a temperature below the melting or softening point of the polymer powder. In one example, the preheat temperature can be from about 10° C. to about 30° C. below the melting or softening point. In another example, the preheat temperature can be within 50° C. of the melting of softening point. In a particular example, the preheat temperature can be from about 160° C. to about 170° C. and the polymer powder can be polyamide 12 powder. In another example, the preheat temperature can be about 90° C. to about 100° C. and the polymer powder can be thermoplastic polyamide or thermoplastic polyurethane. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polymer powder below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer powder, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass.

The three-dimensional printed article can be formed by jetting a fusing agent onto layers of powder bed build material according to a three-dimensional object model. Three-dimensional object models can in some examples be created using computer aided design (CAD) software. Three-dimensional object models can be stored in any suitable file format. In some examples, a three-dimensional printed article as described herein can be based on a single three-dimensional object model. The three-dimensional object model can define the three-dimensional shape of the article Other information may also be included, such as structures to be formed of additional different materials or color data for printing the article with various colors at different locations on the article. The three-dimensional object model may also include features or materials specifically related to jetting fluids on layers of powder bed material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, concentration of the scented compound, and so on. All this information can be contained in a single three-dimensional object file or a combination of multiple files. The three-dimensional printed article can be made based on the three-dimensional object model. As used herein, “based on the three-dimensional object model” can refer to printing using a single three-dimensional object model file or a combination of multiple three-dimensional object models that together define the article. In certain examples, software can be used to convert a three-dimensional object model to instructions for a three-dimensional printer to form the article by building up individual layers of build material.

In an example of the three-dimensional printing process, a thin layer of polymer powder can be spread on a bed to form a powder bed. At the beginning of the process, the powder bed can be empty because no polymer particles have been spread at that point. For the first layer, the polymer particles can be spread onto an empty build platform. The build platform can be a flat surface made of a material sufficient to withstand the heating conditions of the three-dimensional printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the print can increase temperature uniformity of the three-dimensional printed article A fluid jet printing head, such as an inkjet print head, can then be used to print a fusing agent including a radiation absorber over portions of the powder bed corresponding to a thin layer of the three-dimensional article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete three-dimensional article is printed. Thus, “applying individual build material layers of polymer particles to a powder bed” also includes spreading layers of polymer particles over the loose particles and fused layers beneath the new layer of polymer particles.

### Definitions

It is noted that, as used in this specification and the appended claims, the singular forms “a,” “an,” and “the” include plural referents unless the context clearly dictates otherwise.

As used herein, “colorant” can include dyes and/or pigments. As used herein, “dye” refers to compounds or molecules that absorb electromagnetic radiation or certain wavelengths thereof. Dyes can impart a visible color to an ink if the dyes absorb wavelengths in the visible spectrum. Some dyes, however, are used as an electromagnetic radiation absorber and may or may not impart a visible color where applied.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants, and also other pigments such as organometallics, ferrites, ceramics, etc. In one specific aspect, however, the pigment is a pigment colorant.

As used herein, “applying” when referring to fusing agent and/or detailing agent, for example, refers to any technology that can be used to put or place the respective fluid agent on or into a layer of powder bed material for forming three-dimensional articles. For example, “applying” may refer to “jetting.” “ejecting.” “dropping,” “spraying,” or the like.

As used herein, “jetting” or “ejecting” refers to applying fluid agents or other compositions by expelling from ejection or jetting architecture, such as ink-jet architecture. Ink-jet architecture can include thermal or piezo architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context. When using the term “substantial” or “substantially” in the negative, e.g., substantially devoid of a material, what is meant is that none of that material is present, or at most, trace amounts could be present at a concentration that would not impact the function or properties of the composition as a whole.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though an individual member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Example 1—Coating Formulation

An example coating formulation is set forth in Table 1.

TABLE 1

| Component Class | Component | Composition (wt. %) |
|---|---|---|
| Flame retardant | Iodixanol | 10 |
| Flim-forming | Joncryl 683 | 10 |
| polymer | | |
| Solvent | 1,2-butanediol | 20 |
| | DI Water | Balance |
| Surfactant | TEGO ® Twin | 0.40 |
| | 4000 | |
| | Tergitol ™ 15-S-7 | 0.95 |

The coating formulation is tailored to maximize wettability of polyamide-12 (PA-12) plastic articles since PA-12 is a commonly used structural polymer used in MJF three-dimensional printing. The coating formulation is also tailored to enhance evaporation of residual solvents.

### Example 2—Three-Dimensional Printing

Several three-dimensional print tests of 3 mm, 2 mm, and 1 mm testing coupons were carried out using a multi jet fusion process. The fusing agent was loaded in an HP Multi Jet Fusion™ three-dimensional test printer. The powder bed material was polyamide-12 (PA-12) powder. A common MJF fusing agent known as Zebra fusing agent (FA) was used.

The coupons were coated with the iodixanol coating composition of Example 1 by dipping the coupons into the coating. Testing was performed using the industry-recognized UL94 method, with graded performance approximations made according to the UL94 vertical burn standard. The general flame testing process is summarized as:
1. Part is subjected to a flame for 10 seconds
2. Part is removed from flame, and the time it takes for extinguishment is recorded
3. Part is immediately again subjected to a flame for 10 additional seconds
4. Part is removed from the flame and the time it takes for extinguishment is recorded

Table 2 highlights the enhanced flammability performance of the PA-12 coupons coated with the iodixanol coating formulation of Example 1 as compared with PA-12 coupons without coating.

TABLE 2

| | Thickness | | UL 94 | UL 94 |
|---|---|---|---|---|
| | (coupon + | | Performance | Performance |
| Sample | coating) | Coating | (1^{st} | (2^{nd} |
| # | (mm) | Used? | extinguish time) | extinguish time) |
| 1 | 3 | No | Fail | N/A |
| 2 | 3 | No | Fail | N/A |
| 3 | 3 | No | Fail | N/A |
| 4 | 3 | Yes | Pass | Pass |
| 5 | 3 | Yes | Pass | Pass |
| 6 | 3 | Yes | Pass | Pass |
| 7 | 3 | Yes | Pass | Pass |
| 8 | 2 | Yes | Pass | Pass |
| 9 | 2 | Yes | Pass | Pass |
| 10 | 1 | Yes | Pass | Fail |

The performance results indicate that the coupons coated with iodixanol had exceptional fire resistance compared with the control (without coating) coupons, demonstrating UL 94 V-1/V-2 performance down to coupon thickness of 2 mm.

While it is understood that within the disclosure are various optimizations of the coating formulation with respect to the Examples to adapt to various three-dimensional printed articles to ensure maximal application of the coating to the articles. Such optimizations may include concentrations, alternative surfactants, additional film-forming additives to enhance durability, and alternative solvents to name a few. The coating formulation may also be combined with or used in addition to other fire resistant materials and coatings.

What is claimed is:

1. A composition for coating a three-dimensional printed article, the composition comprising:
at least one non-polymeric, polyhalogenated organic compound,
at least one surfactant, and
at least one solvent,
wherein the composition optionally includes at least one film forming polymer at a concentration of up to about 10 wt. % of the composition.

2. The composition of claim 1, wherein the at least one polyhalogenated organic compound is at least one selected from the group consisting of diatrizoate, iodixanol, iohexol, iopamidol, ioxilan, ioversol, iomeprol, iobitridol, iopentol, ioforminol, diacetyliodixanol, iopiperidol, and iosimenol.

3. The composition of claim 2, wherein the at least one polyhalogenated organic compound includes iodixanol.

4. The composition of claim 1, wherein the composition includes the at least one film forming polymer at a concentration of up to 10 wt. % of the composition.

5. The composition of claim 4, wherein the composition does not include additional polymers other than the film forming polymer.

6. The composition of claim 1, wherein the at least one surfactant includes a nonionic surfactant.

7. The composition of claim 1, wherein the at least one surfactant is included at a concentration ranging between about 0.1 wt % and 4 wt. % of the composition.

8. A method of making a flame-resistant coated article, the method comprising:
coating the article with a liquid flame retardant composition, the composition comprising at least one polyhalogenated organic compound, at least one surfactant, at least one solvent, and optionally at least one film forming polymer at a concentration of up to about 10 wt. % of the composition, wherein the article is a three-dimensional printed article.

9. The method according to claim 8, wherein the composition includes the at least one film forming polymer at a concentration of up to 10 wt. % of the composition.

10. The method of claim 8, wherein the composition does not include additional polymers other than the film forming polymer.

11. The method of claim 8, wherein the at least one surfactant is included at a concentration ranging between about 0.1 wt % and 4 wt. % of the composition.

12. The method of claim 8, wherein the article is a three-dimensional printed article formed using multi-jet fusion.

13. The method of claim 8, wherein the article is formed from at least one polymer selected from the group consisting of polyamide 6 powder, polyamide 9 powder, polyamide 11 powder, polyamide 12 powder, polyamide 6/6 powder, polyamide 6/12 powder, thermoplastic polyamide powder, polyamide copolymer powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, silicone rubber, polypropylene powder, polyester powder, polycarbonate powder, copolymers of polycarbonate with acrylonitrile butadiene styrene, copolymers of polycarbonate with polyethylene terephthalate, polyether ketone powder, polyacrylate powder, polystyrene powder, polyvinylidene fluoride powder, polyvinylidene fluoride copolymer powder, poly(vinylidene fluoride-trifluoroethylene) powder, poly(vinylidene fluoride-trifluoroethylene-chlorotrifluoroethylene) powder, and mixtures thereof.

14. The method of claim 8, wherein the polyhalogenated organic compound is at least one selected from the group consisting of diatrizoate, iodixanol, iohexol, iopamidol, ioxilan, ioversol, iomeprol, iobitridol, iopentol, ioforminol, diacetyliodixanol, iopiperidol, and iosimenol.

15. The method of claim 8, wherein the polyhalogenated organic compound is iodixanol.
